(19) United States
(12) Patent Application Publication
(10) Pub. No.: US 2024/0094480 A1
(43) Pub. Date: Mar. 21, 2024

(54) MEDIA OVER FIBER OPTIC PASS-THROUGH CABLING SYSTEM AND METHOD

(71) Applicant: NSI-LYNN ELECTRONICS, LLC, NORTH WALES, PA (US)

(72) Inventors: Cameron Smith, Prairie du Sac, WI (US); Christopher John Melendy, Sun Prairie, WI (US)

(21) Appl. No.: 18/256,541

(22) PCT Filed: Jul. 29, 2022
(86) PCT No.: PCT/US2022/074304

§ 371 Date: Jun. 8, 2023

Related U.S. Application Data
(60) Provisional application No. 63/239,548, filed on Sep. 1, 2021.

(51) Int. Cl. G02B 6/38; A47B 21/06

(52) U.S. Cl. CPC G02B 6/3897; A47B 21/06; A47B 2021/066

(57) ABSTRACT

A cabling system for extending electronic signals between devices is disclosed. The cabling system includes an extension cable connecting a female source connector and a destination connecter. The female source connector is housed within a headshell that is configured to mount to a wallplate, a table insert, or a rack panel within meeting and conference locations.

### FIELD

This invention relates to media signal transfer systems, and more specifically to transferring electronic media over a fiber optic pass-through cabling system.

### BACKGROUND OF THE INVENTION

Current cabling systems for audiovisual (AV) and data signals limit data transfer to a distance of approximately two to five meters. Current systems include mounting a small whip or adapter to a plate and/or using two male-to-male cables connected with an adapter. In an effort to achieve data transfer over a greater distance, hybrid cables, for example cables comprised of optical glass fiber and copper are already in use to directly connect distantly-connected electronic devices but generally have male-to-male connectors. The present invention provides a cabling system capable of data transfer over distances up to 100 meters without utilizing male-to-male connectors to connect multiple cables.

### BRIEF SUMMARY

The present invention is capable of extending data transfer over media cable by providing a cabling system as described herein.

In one aspect, a media cable is described. The media cable comprising an extension cable comprising active optical cable, a female source connector housed within a headshell, and a destination connector. In some embodiments, the media cable further comprises a wallplate, and the headshell is configured to mount to the wallplate. Additionally, or alternatively, the media cable further comprises a table insert, and the headshell is configured to mount to the table insert. Additionally, or alternatively, the media cable further comprises a panel insert, and the headshell is configured to mount to the rack panel. In some embodiments, the female source connector is an HDMI-port. Additionally, or alternatively, the female source connector is a USB-port. In other embodiments, the female source connector is a DisplayPort-port.

In another aspect, a cable system is described. The cabling system comprising at least one extension cable comprised of active optical cable. The at least one extension cable comprises a female source connector housed within a headshell and a destination connector. In some embodiments, the cabling system comprises a wallplate mounted to the headshell. Additionally, or alternatively, the cabling system comprises a table insert mounted to the headshell. Additionally, or alternatively, the cabling system comprises a rack panel mounted to the headshell. In other embodiments, the cabling system comprises intermediary equipment. In some embodiments, intermediary equipment may include an AV splitter, an AV switcher, or an AV matrix. In some embodiments, the female source connector is an HDMI-port. Additionally, or alternatively, the female source connector is a USB-port. In other embodiments, the female source connector is a DisplayPort-port.

In another aspect, a panel mounted connection interface is described. The panel mounted connection interface comprising at least one female source connector housed within a headshell mounted to a panel. In some embodiments, the panel is wall-mounted. Additionally, or alternatively, the panel is table-mounted. Additionally, or alternatively, the panel is rack-mounted. In some embodiments, the female source connector is coupled to a destination connector via an extension cable comprising active optical cable. In some embodiments, the female source connector is an HDMI-port. Additionally, or alternatively, the female source connector is a USB-port. In other embodiments, the female source connector is a DisplayPort-port.

### BRIEF DESCRIPTION OF THE DRAWINGS

Some of the objects of the invention have been set forth above. Other objects and advantages of the invention will become evident as the description of the invention is read in conjunction with the following drawings.

FIG. 1 is a front elevation view of a headshell, in accordance with an embodiment of the present invention.

FIG. 2 is a side elevation view of a headshell, in accordance with an embodiment of the present invention.

FIG. 3 is a front and side elevation view of a table insert, in accordance with an embodiment of the present invention.

FIG. 4 is a front and side elevation view of a, in accordance with an embodiment of the present invention.

FIG. 5 is a front view of a dual application wallplate, in accordance with an embodiment of the present invention.

FIG. 6 is a perspective view of a headshell, in accordance with an embodiment of the present invention.

FIG. 7 is an internal view of a headshell, in accordance with an embodiment of the present invention.

FIG. 8 is a block diagram illustrating a simple meeting room arrangement, in accordance with an embodiment of the present invention.

FIG. 9 is a block diagram illustrating a complex meeting room arrangement, in accordance with an embodiment of the present invention.

FIG. 10 is a block diagram illustrating a simple conference room arrangement, in accordance with an embodiment of the present invention.

FIG. 11 is block diagram illustrating a complex conference room arrangement, in accordance with an embodiment of the present invention.

FIG. 12 is a block diagram illustrating a simple meeting room arrangement, in accordance with an embodiment of the present invention.

FIG. 13 is a block diagram illustrating an advanced meeting room arrangement, in accordance with an embodiment of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. The invention may be embodied in many different forms and should not be construed as limited to the embodiments set forth herein; rather these embodiments are provided so that this disclosure will satisfy applicable legal requirements Like numbers refer to like elements throughout.

According to one aspect of the invention, novel uses are made of existing electronic signal transfer technology and components. According to another aspect of the invention, signal transfer distance is greatly increased. According to another aspect of the invention, mobile devices, for example, phones, tablets and laptops, may be connected into integrated systems without access to subcomponents of the systems.

These and other aspects of the invention are achieved by providing a cabling system configured to extend electronic signals from a digital user device through an optical glass fiber cable interface to a user-accessible connector and to remotely-connected digital equipment. A cabling system is provided wherein the remotely-connected digital equipment is audio-visual equipment. At least one end of or both ends of the cable includes a female connector and is adapted to permit attachment of a lead-in cable to connect a relatively short distance from the digital user device to the interface.

The novel cabling system extends audiovisual (AV) and data signals from a user-accessible interface plate, for example, on a wall or on a table, to permanently connected equipment such as switch gear or a display. This ability allows casual users to plug in mobile devices, for example, phones, tablets and laptops, into integrated systems without access to the subcomponents. Hybrid cables, for example cables comprised of optical glass fiber and copper are already in use to directly connect distantly-connected electronic devices but generally have male-to-male connectors. As described below, one novel feature of the invention changes one cable connector to a female connector with mounting points, and introduces a new mounting system for the female cable connector that allows it to be mounted to different types of interface plates, for example wallplates, table inserts, or equipment rack panels.

The invention comprises a group of devices designed to make extending and connecting audio, video, and data signals from source to display easier for users to manage. It is intended to be installed permanently within a building to be used in conjunction with other data systems. The novel devices according to the invention include a panel-mounted connection interface, for example, a wallplate, table insert or rack panel by which users can connect and disconnect various electronic devices such as phones, tablets, gaming controllers and laptops.

An extension cable of a specified length is provided that includes an internal optical glass fiber cable wire for high speed data transmission. The extension cable utilizes a hybrid cable, i.e., a combination of optical glass fiber and insulated conductors commonly known as an Active Optical Cable (“AOC”) to transmit the audio, video, and/or data signals distances not achievable through a common cable having only insulated conductors. Unlike other types of cables normally used, a modification is made to one or both ends of the cable to provide a female connector instead of the standard male connector, which will allow a ‘lead-in’ or ‘patch’ cable to connect the short distance from the user device, a laptop for example, to the interface.

The wallplate interface allows a source device to be connected and disconnected from the extension cable by the use of a ‘lead-in’ or ‘patch’. The design of the wallplate allows the female end of the extension cable to be affixed to the backside of the wallplate. The source connector and wallplate are then installed into a standard low-voltage electrical box, with the other end of the cable, comprising a destination connector, being run through the building infrastructure and connected to another electronic device via the destination connector. In the case of a video signal (HDMI-PORT, DisplayPort-PORT, etc.) the destination connector is usually connected to audio/visual (AV) equipment such as a television, a projector, speaker(s), microphones, etc.; but it is also possible to connect intermediary equipment, such as video switchers, splitters, or matrices, which may then be coupled to the AV equipment.

The connection interfaces are modular whereby extension cables of different types such as HDMI-PORT, USB-PORT and DisplayPort-PORT can be grouped together. The system is capable of transmitting signals at distances of 100 m or more from the signal origin. The installation design of the interface design may be based on common standards—for example the wallplate size, materials, layout, and color are based on existing standards in the construction industry, thereby ensuring continuity with existing devices such as electrical outlets, switches, and cover plates.

In accordance with the invention, reliable data connections for greater than 70 m (230 ft) are currently achievable with lengths up to 300 m being feasible. The distance limitations of the extension cable vary slightly by media type and bandwidth, USB-PORT 2.0 @ 480 mbps vs USB-PORT 3.0 @ 5 gbps, for example. Various standards that determine operation parameters include: HDMI-PORT 1.4-1.4(b); HDMI-PORT 2.0-2.0(b); HDMI-PORT 2.1; DisplayPort-PORT 1.4-1.4a (VESA); DisplayPort-PORT 2.0 (VESA); USB-PORT 1.0-1.1; USB-PORT 2.0; USB-PORT 3.0-3.2; USB-PORT 4; USB-PORT-C; US NEC Section 800 (NFPA 70). In some embodiments, the extension cable may be between 5 meters and 100 meters. Additionally, or alternatively, the extension cable may be between 5 meters and 50 meters. In some embodiments, the extension cable may be 5 meters. In other embodiments the extension cable may be 8 meters. Additionally, or alternatively, the extension cable may be 10 meters. In some embodiments, the extension cable may be 15 meters. In other embodiments, the extension cable may be 23 meters. Additionally, or alternatively, the extension cable may be 30 meters. In some embodiments, the extension cable may be 50 meters.

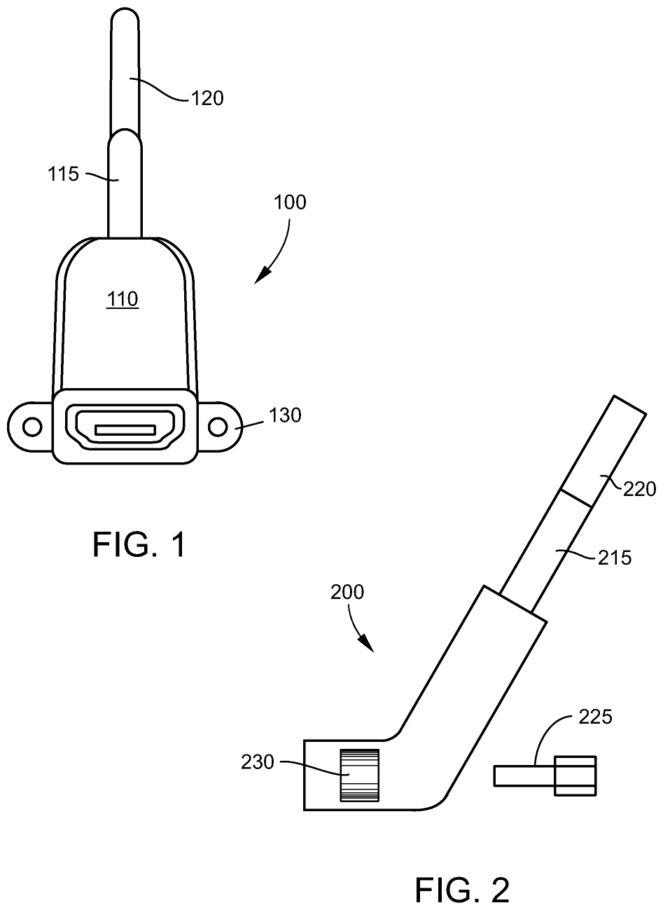

FIG. 1 illustrates a front elevation view of a source connector end of a media cable in accordance with an embodiment of the present invention. The media cable described herein, comprises an extension cable 120, within a cable jacket 115. The source connector end of the media cable comprises a headshell 110. In the embodiment represented in FIG. 1, the headshell houses a female HDMI-PORT (High-Definition Multimedia Interface) source connector. The headshell shown in FIG. 1 is also configured to mount to a wallplate or a table insert via a connector 130. FIG. 2 illustrates a side elevation view of a source connector end of a media cable 200 in accordance with an embodiment of the present invention. The media cable represented in the embodiment shown in FIG. 2 comprises an extension cable 220 within a cable jacket 215. The mounting mechanism represented in FIG. 2 includes a connector 230, configured to mount a wallplate or table insert by use of a screw 225.

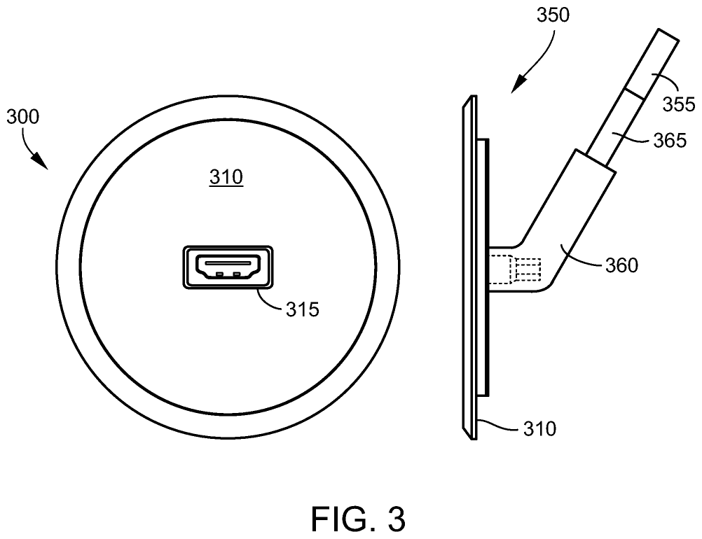

FIG. 3 illustrates a front view table insert 300 in accordance with an embodiment of the present invention, and a side-view of the table insert 350. The table insert panel 310 may be made of plastic or metal. In some embodiments, the table insert panel is made of furniture grade aluminum. The table insert panel 310 includes a female source connector 315, in the embodiment shown in FIG. 3 the female source connector 315 is an HDMI-PORT source connector housed within a headshell 360. In some embodiments, there is more than one female source connector coupled to the table insert panel 310. Additionally, or alternatively, the female source connector 315 may be a USB-PORT source connector. In other embodiments, the female source connector 315 may be a DisplayPort-PORT. The headshell 360 is coupled to a media cable 355 within a cable jacket 365.

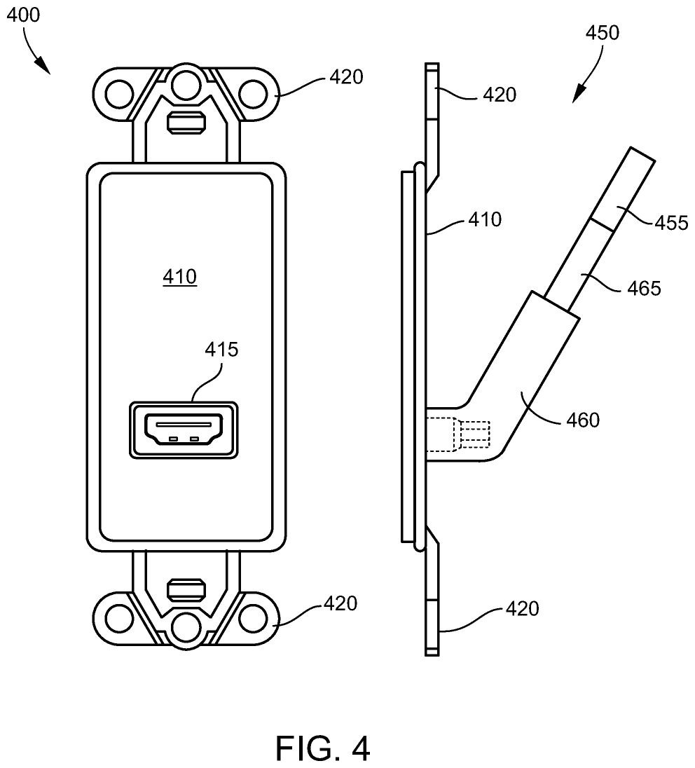

Similarly, FIG. 4 illustrates a front view of a wallplate 400 in accordance with an embodiment of the present invention, and a side-view of the wallplate 450. The wallplate panel 410 may be made of plastic or metal. In some embodiments, the wallplate panel 410 is made of furniture grade aluminum. The wallplate panel 410 includes a female source connector 415, in the embodiment illustrated in FIG. 4, the female source connector 415 is an HDMI-PORT source connector housed within a headshell 460. In some embodiments, there is more than one female source connector coupled to the table insert panel 410. Additionally, or alternatively, the female source connector 415 may be a USB-PORT source connector. In other embodiments, the female source connector 415 may be a DisplayPort-PORT. The headshell 460 is coupled to a media cable 455 within a cable jacket 465. The wallplate panel 410, further includes mounting ears 420 configured to mount to a standard electrical box.

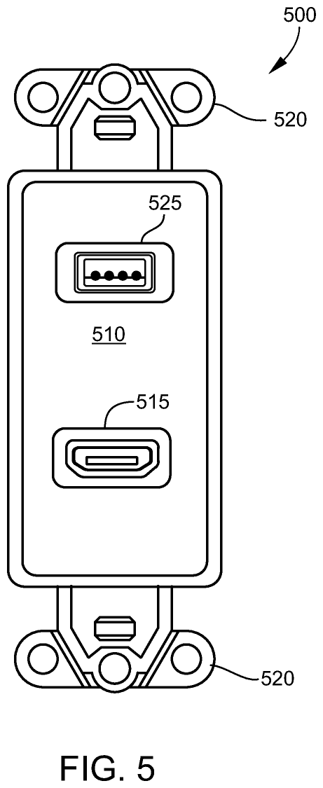

FIG. 5 illustrates a wallplate panel 510, according to an embodiment of the present invention. The embodiment illustrated in FIG. 5 represents a wallplate panel 510 with two female source connectors 525 and 515. In this embodiment represented in FIG. 5 a first source connector 525 is a USB-PORT source connector and a second source connector 515 is an HDMI-port source connector, however other combinations are possible. The wallplate panel 510 further includes mounting ears 520 configured to mount to a standard electrical box.

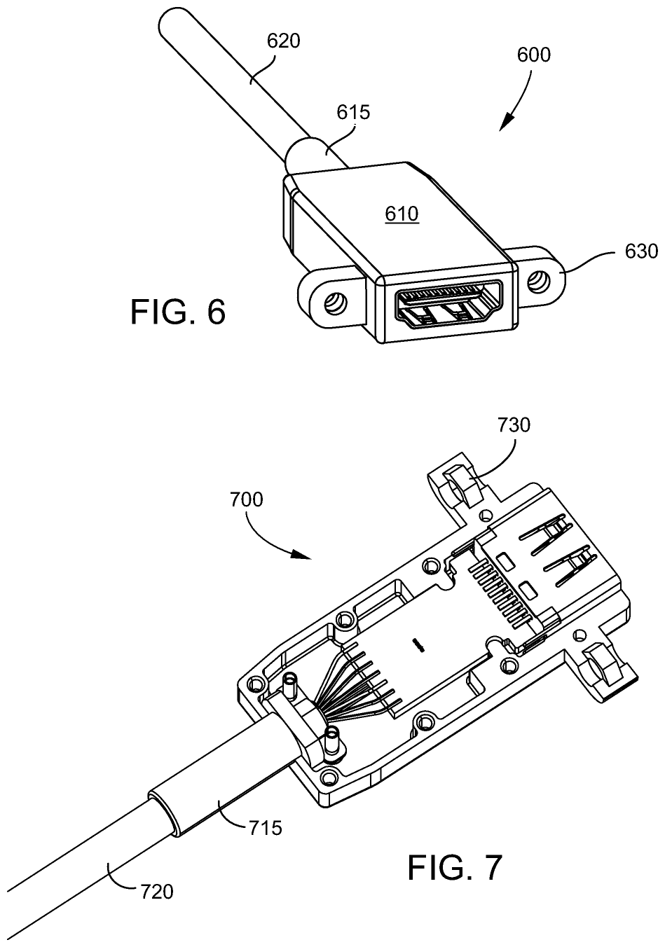

FIG. 6 is a perspective view of a female HDMI-PORT headshell 600 in accordance with an embodiment of the present invention coupled to an extension cable 620 within a cable jacket 615. The headshell 610 houses a female HDMI-port source connector. The headshell further comprises a connector 630 configured to mount a wallplate panel, a table insert panel, or an equipment rack panel. In some embodiments, the connector 630 is a hexnut. FIG. 7 is an internal view of a headshell 700 in accordance with an embodiment of the present invention. The headshell of FIG. 7 is coupled to an extension cable 720 within a cable jacket 715. The headshell also comprises a connector 630 configured to mount the headshell to a wallplate, table insert, or equipment rack panel.

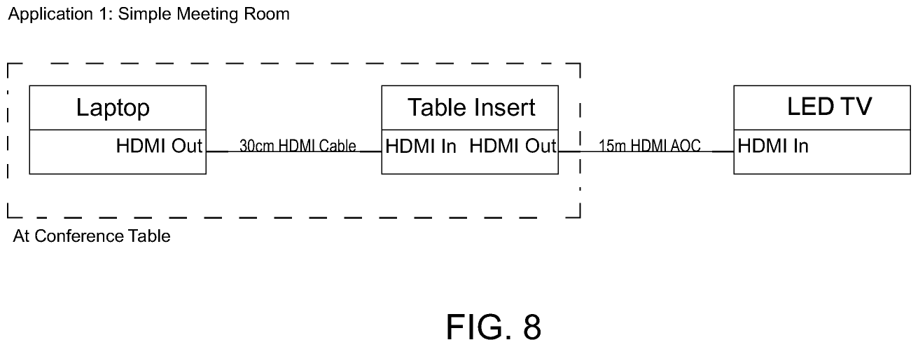

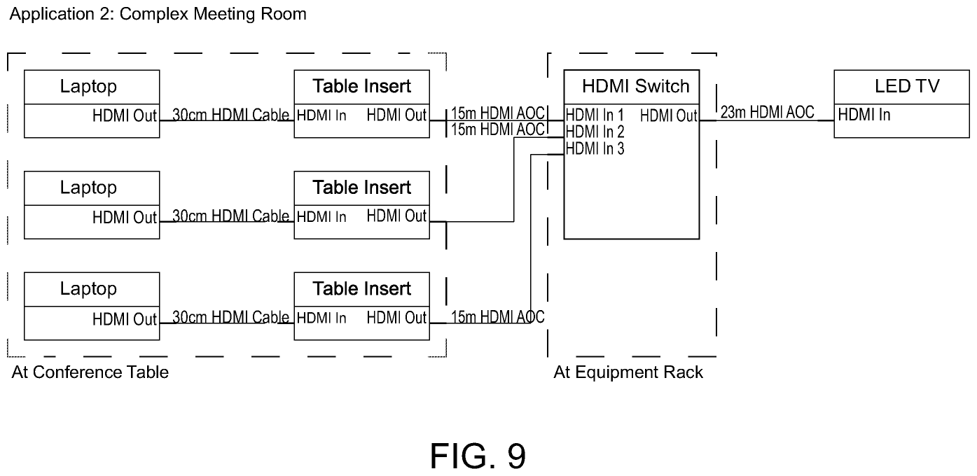

FIGS. 8-13 illustrate example meeting and conference room setups enabled by the present technology. FIGS. 8-13 are provided for exemplary purposes and that various subparts may be substituted. For example, a female HDMI-port source connector may be substituted for a USB-port or DisplayPort-PORT and the cable lengths may be of various lengths. FIG. 8 illustrates a simple meeting room. The simple meeting room shown in FIG. 8 comprises a laptop equipped with an HDMI-port outlet connected via a 10 cm HDMI lead-in cable to a table insert that is equipped with a female HDMI-port source connector. The table insert is connected to an LED TV by a 15 meter HDMI AOC. A complex meeting room is illustrated in FIG. 9 where there are multiple laptops connected to the female source connector of table inserts via a 30 cm HDMI lead-in cable. Each table insert is connected via a 15 meter HDMI AOC to an equipment rack containing an HDMI switch that is coupled to an LED TV via a 23 meter HDMI AOC.

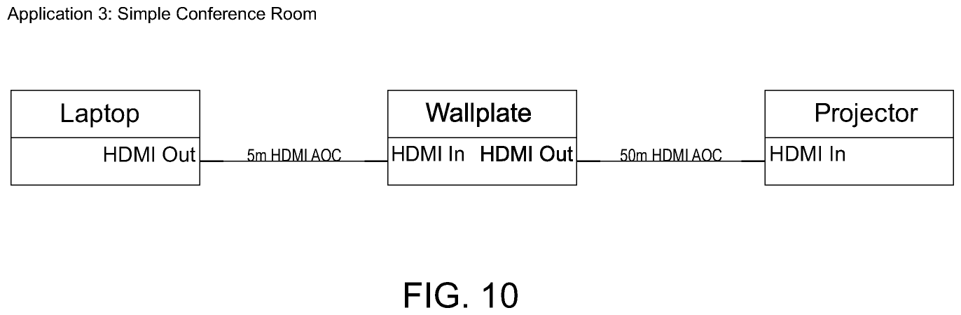

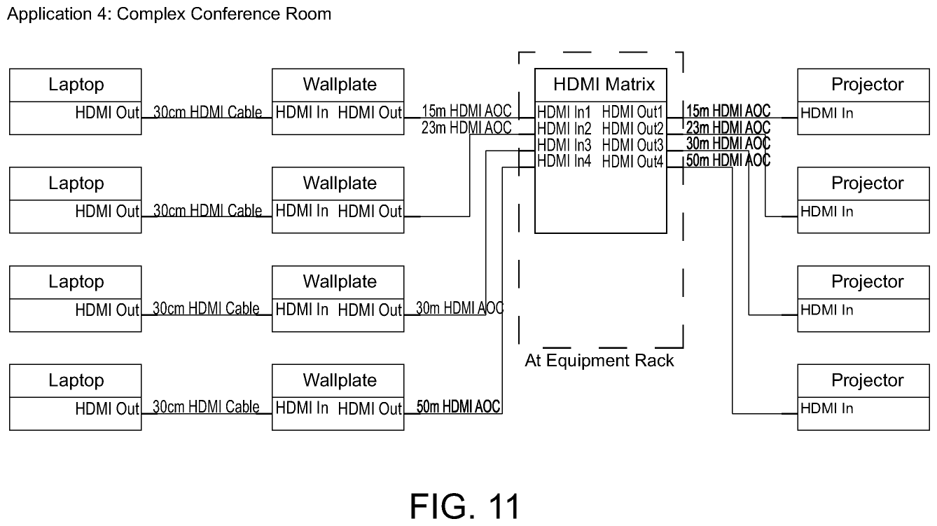

FIG. 10 illustrates a simple conference room, wherein a laptop is connected to a wallplate via a 5 meter HDMI lead-in AOC. The wallplate is equipped with a female HDMI-port source connector, and coupled to a projector via a 50 meter HDMI AOC. FIG. 11 illustrate a complex conference room with multiple laptops. Each laptop is connected to a wallplate via a 30 cm HDMI lead-in cable. Each wallplate equipped with a female HDMI-port source connector and connected to an HDMI-PORT Matrix at an equipment rack by an appropriately long HDMI AOC. The HDMI Matrix is connected to projectors via HDMI AOCs.

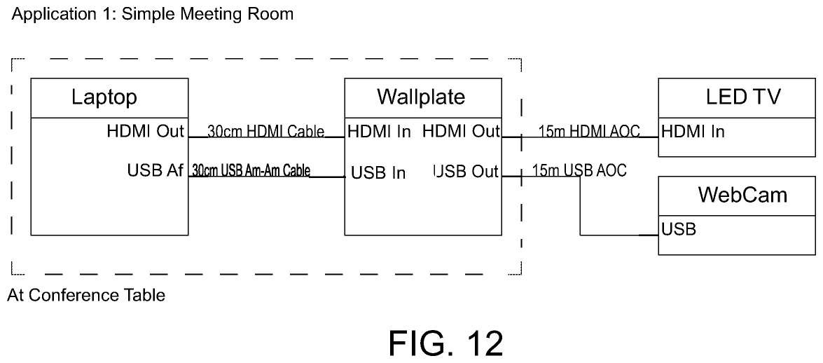

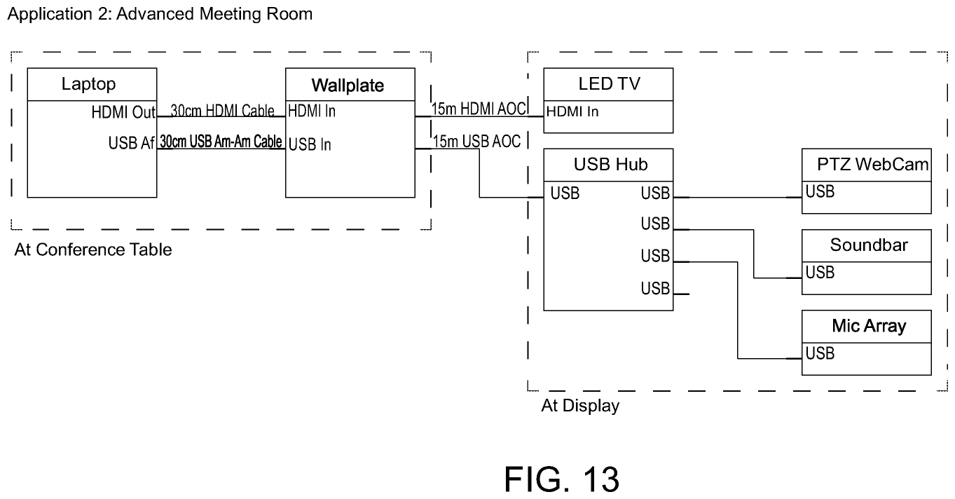

FIG. 12 illustrates a simple meeting room equipped with a dual-function wallplate. A laptop is connected to a wallplate via a 30 cm HDMI lead-in cable and a 30 cm USB lead-in Cable. The wallplate is equipped with a female HDMI-port source connector and a female USB-port source connector. The wallplate is coupled to an LED TV via a 15 meter HDMI AOC and a WebCam via a 15 meter USB AOC. FIG. 13 illustrates an advanced meeting room equipped with a dual function wallplate. A laptop is connected to a wallplate via a 30 cm HDMI lead-in cable and a 30 cm USB lead-in Cable. The wallplate is equipped with a female HDMI-port source connector and a female USB-port source connector. The wallplate is connected to an LED TV via a 15 meter HDMI AOC and to a USB-Hub via a 15 meter USB AOC. The USB-Hub is configured to communicate with a WebCam, a Soundbar, and a Microphone Array.

While the written description herein enables one of ordinary skill in the art to make and use the present invention, those of ordinary skill in the art will appreciate that there exists variations, combinations, and equivalents of the specific embodiments and examples described herein. The invention should therefore not be limited by the specified examples.

1. A media cable comprising:
an extension cable having a first end and a second end, wherein the extension cable comprises active optical cable, and wherein the extension cable is at least five meters in length;
a female source connector coupled to the first end of the extension cable, wherein the female source connector is housed within a headshell; and
a destination connector coupled to the second end of the extension cable.

2. The media cable according to claim 1, further comprising a wallplate, wherein the headshell is configured to mount to the wallplate.

3. The media cable according to claim 1, further comprising a table insert, wherein the headshell is configured to mount to the table insert.

4. The media cable according to claim 1, wherein the headshell is configured to mount to a rack-panel.

5. The media cable according to claim 1, wherein the female source connector is selected from the group consisting of HDMI-port, USB-port, and DisplayPort-port.

6. A cabling system comprising at least one extension cable comprised of active optical cable, wherein the at least one extension cable comprises, at a first end, a female source connector housed within a headshell and, at a second end, a destination connector, and wherein the cabling system lacks a male-to-male connector.

7. The cabling system according to claim 6, further comprising at least one wallplate, wherein the headshell is configured to mount to the wallplate.

8. The cabling system according to claim 6, further comprising at least one table insert, wherein the headshell is configured to mount to the table insert.

9. The cabling system according to claim 6, wherein the female source connector is selected from the group consisting of HDMI-port, USB-port, and DisplayPort-port.

10. The cabling system according to claim 6, further comprising intermediary equipment.

11. The cabling system according to claim 10, wherein the intermediary equipment is at least one of a switcher, a splitter, or a matrix.

12. A panel mounted connection interface comprising at least one female source connector housed within a headshell mounted to a panel, wherein the at least one female source connector is coupled to a destination connector via a continuous extension cable comprising active optical cable, wherein the extension cable is at least five meters in length.

13. The panel mounted connection interface according to claim 12, wherein the at least one female source connector is selected from the group consisting of HDMI-port, USB-port, and DisplayPort-port.

14. The panel mounted connection interface according to claim 12, wherein the panel is wall-mounted.

15. The panel mounted connection interface according to claim 12, wherein the panel is table-mounted.

16. The panel mounted connection interface according to claim 12, wherein the panel is rack-mounted.

17. A cable system for transferring data, the cabling system comprising:
an extension cable comprising active optical cable, wherein the extension cable has a first end and a second end, and wherein the extension cable is at least five meters long;
at least one headshell coupled to the first end of the extension cable, wherein the at least one headshell comprises a female source connector, wherein the female source connector is an HDMI-port, a USB-port, or a DisplayPort-port, wherein the at least one headshell comprises a connector configured to mount to a panel, and wherein the panel is a wallplate panel, a table insert panel, or a rack panel; and
a destination connector coupled to the second end of the extension cable, wherein the destination connector connects directly to audio visual equipment or indirectly to audio visual equipment through intermediary equipment.
